(19) United States
(12) Patent Application Publication
(10) Pub. No.: US 2025/0273364 A1
(43) Pub. Date: Aug. 28, 2025

(54) A MULTI-LAYERED LIGHTWEIGHT HIGH-VOLTAGE ELECTRICAL CABLE, A METHOD OF STRIPPING AN ELECTRICAL CABLE, AND A KIT

(71) Applicant: Habia Cable Aktiebolag, UPPLANDS VÄSBY (SE)

(72) Inventors: Richard L. ANDERSSON, Kista (SE); Pär Anders HÖGSTRÖM, Hudiksvall (SE)

(73) Assignee: Habia Cable Aktiebolag, UPPLANDS VÄSBY (SE)

(21) Appl. No.: 18/856,823

(22) PCT Filed: Apr. 27, 2023
(86) PCT No.: PCT/SE2023/050396

§ 371 Date: Oct. 14, 2024

(30) Foreign Application Priority Data
Apr. 27, 2022 (SE) 2230123-8

(51) Int. Cl. H01B 9/02; C08K 3/04; H01B 3/44; H02G 1/12

(52) U.S. Cl. CPC H01B 9/027; C08K 3/04; H01B 3/445; H02G 1/12; C08K 2201/005

(57) ABSTRACT

The disclosure relates to a multi-layered lightweight high-voltage electrical cable 1, comprising: a bundle 2 of metallic wires 3; an inner semi-conductive layer 4, made of a first broad range temperature rated polymeric material of a first color, surrounding said bundle 2 of metallic wires 3; at least one of the metallic wires 3 being in electric contact with the inner semi-conductive layer 4; an insulating layer 5, made of a second broad range temperature rated polymeric material of a second color, surrounding the inner semi-conductive layer 4; an outer semi-conductive layer 6, made of a third broad range temperature rated polymeric material of a third color, surrounding and having a void-free and delamination-resistant bond to the insulating layer 5; the second color and the third color contrasting with each other. The disclosure further relates to a method of stripping an electrical cable 1 and a kit for correct stripping.

### TECHNICAL FIELD

The present invention relates to a multi-layered lightweight high-voltage (MLLWHV) electrical cable, a method of stripping an electrical cable, and a kit related to correct electrical cable stripping. More specifically, the invention relates to a MLLWHV electrical cable having a bundle of metallic wires surrounded by an inner semi-conductive layer in electric contact with at least one of the metallic wires, an insulating layer, and an outer semi-conductive layer, all three layers made of broad range temperature rated polymeric material, wherein the outer semi-conductive layer is bonded by a void-free and delamination-resistant (VFDR) bond to the insulating layer. The electrical cable has VFDR bonding to prevent partial discharge. This is crucial for the high voltage properties of the electrical cable.

### BACKGROUND AND RELATED ART

A MLLWHV electrical cable with a VFDR bond, which is known from the prior art, has a black inner semi-conductive layer surrounding metallic wires, then an essentially colorless insulating layer and, VFDR bonded thereto, a black outer semi-conductive layer. To terminate or join two segments of such an electrical cable, stripping of surrounding semi-conductive and insulating layers to allow access to the metal wires is necessary. Also, the outer semi-conductive layer needs to be stripped away completely, much further from the cable's end than the insulating layer and the inner semi-conductive layer. Otherwise, there will be a risk of discharge between the metallic wires and the outer semi-conductive layer, including any unintentional residue thereof, to a surrounding conductor or a semi-conductor, such as the outer semi-conductive layer. A conventional tool for such stripping is operated like a lathe, supported by the outer perimeter of the electrical cable. In the same action, this stripping tool should typically cut away the outer semi-conductive layer and, to ensure its complete removal, also a thin outermost portion of the insulating layer.

However, a problem using this or any other known stripping tool in combination with an essentially colorless or dark insulation layer is that it is difficult to ensure by inspection whether the outer semi-conductive layer has been completely removed, while aiming to save as much radial thickness as possible of the insulating layer. Further, it may be difficult to ensure by inspection that enough of the insulating layer remains after the stripping. Known MLLWHV electrical cables do not facilitate the secure determination of whether correct stripping has been achieved. It is particularly difficult to ensure correct stripping of a MLLWHV electrical cable having a thin insulating layer, since higher precision is needed (as there is less tolerance for errors in absolute cutting depth). There is thus a need for improvements in ensuring by inspection that an electrical wire of this type has been correctly stripped prior to forming a joint or a termination.

### SUMMARY

It is an object of the present invention to mitigate, alleviate or eliminate one or more of the above-identified deficiencies and disadvantages in the prior art and solve at least the above mentioned problem. According to the invention, there is provided a multi-layered lightweight high-voltage electrical cable, comprising: a bundle of metallic wires; an inner semi-conductive layer, made of a first broad range temperature rated polymeric material of a first color, surrounding the bundle of metallic wires; at least one of the metallic wires being in electric contact with the inner semi-conductive layer; an insulating layer, made of a second broad range temperature rated polymeric material of a second color, surrounding the inner semi-conductive layer; an outer semi-conductive layer, made of a third broad range temperature rated polymeric material of a third color, surrounding and having a void-free and delamination-resistant bond (VFDR bond) to the insulating layer, the second color and the third color contrasting with each other.

The term contrasting in this disclosure implies a clearly visible difference in perceived lightness and/or wavelength dependent appearance, so that contrasting materials of contrasting colors can be clearly separated by a human eye.

The VFDR bond between the outer semi-conductive layer and the insulating layer should not contain voids or pockets of gas (or comparable contamination), because those would create a risk of partial discharge occurring when the inventive electrical cable is used in high-voltage operation. Further, the VFDR bond is so strong that no conventional tearing, peeling, or sliding of the outer semi-conductive layer will ensure its complete removal from the insulating layer.

For its removal, the VFDR bond between the outer semi-conductive layer and the insulating layer requires a material subtraction technique to be used. Such material subtraction techniques include cutting techniques, for instance, by a cutting edge or laser, and abrasive or grinding techniques. In the process of properly stripping the outer semi-conductive layer, the VFDR bond should be removed at least to the effect that no semi-conductive material (of the outer semi-conductive layer) remains that could otherwise pose a discharge risk.

If present, any VFDR bond between the inner semi-conductive layer and the insulating layer shall have characteristics corresponding to that between the outer semi-conductive layer and the insulating layer, as described above.

Typically and preferably, the first and third colors are black because of the semi-conductive properties of the respective materials are attained by mixing of black carbon particles in their polymer constituent materials. Other first and third colors should be possible to attain, but this has not been further explored by the inventor. A light second color, such as white or essentially white, would be suitable. Preferably, the second color property of the insulating layer is attained through a second color additive (pigment or other color agent) to the second broad range temperature rated polymeric material (colorless in itself). An advantage having contrasting second and third colors is that inspection will easily reveal (black on white) whether any parts of the outer semi-conductive layer remain after the stripping, so that additional removal or another attempt at stripping (after cutting faulty portion) with a re-calibrated tool may be carried out. Possibly, the polymer shavings resulting from the stripping could be inspected for ensuring that not too much of the insulating layer was removed simultaneously with the outer semi-conductive layer.

However, it is better to provide translucency of the insulating layer. This option can be expressed either as: the first color and the second color contrasting with each other; the insulating layer being translucent, such that the first color of the inner semi-conductive layer affects in combination with the second color of the insulating layer a perceived shade of second color when the insulating layer is viewed at its outer perimeter at full radial thickness of the insulating layer (which also means that a perceived shade of the first color is affected by the second color and that there is a mixing of the first and second colors)., and/or as: a translucency of the insulating layer being defined as an optical depth of the insulating layer being greater than or equal to 0.5 and less than or equal to 10. In the case of black inner semi-conductive layer and white translucency of the insulating layer, this range of optical depth is approximately equivalent to a perceived shade of whiteness/lightness of about 0.2 to 0.8, where 1 is completely white (reflecting/scattering back all incoming light) and 0 is completely black (all incoming light traveling through the insulation and is absorbed by the black color of the inner semi-conductive layer), see FIG. 2. The advantage of an insulating layer in a color contrasting to that of the outer semi-conductive layer is particularly pronounced for electrical cables, wherein a manufactured radial thickness of the insulating layer is in a range of 0.4 through 1.6 millimeters (preferably 0.4 mm-1.0 mm), since the requirement for precision in the stripping is very high for such thin insulating layers. The options of translucency of the insulating layer enable an even more precise stripping.

According to the invention, there is further provided a method of stripping the inventive electrical cable, the method comprising: at an end of the electrical cable, stripping away a longitudinal segment of the outer semi-conductive layer and corresponding radially outermost parts of the insulating layer; ensuring, by color inspection, a complete removal of the longitudinal segment of the outer semi-conductive layer from the insulating layer.

According to the invention, there is further provided a kit comprising the inventive electrical cable and a reflectance reference surface to be visually matched against diffuse reflectance of the outer perimeter of the insulating layer after stripping away a longitudinal segment of the outer semi-conductive layer and corresponding radially outermost parts of the insulating layer.

These definitions shall be used in the interpretation of this disclosure:
insulating (material) implies conductivity <10⁻⁹ S/m;
semi-conductive (material) implies conductivity of 10⁻⁴ through 10⁵ S/m;
metallic wire (material) implies conductivity >10⁵ S/m.

A broad range temperature rated polymeric material shall mean herein a material that has a temperature operating range at least up to 120 and, optionally, down to or below −50 degrees centigrade. Fluoropolymers are preferred examples of such broad range temperature rated polymeric materials. In particular FEP, PFA, and ETFE are fluoropolymers suitable for manufacturing of the inventive cables disclosed herein. Aviation is an example of an intended field of use of the inventive electrical cable and necessitates the cable's tolerance to low temperatures due to ambient cold air and high temperatures due to for instance its transmission of high-power or proximity to heat sources.

High voltage shall imply herein electric potential differences under normal operational use greater than or equal to 500 volts AC or DC and less than or equal to 5 kilovolts AC or 30 kilovolts DC between the inner semi-conductive layer and the outer semi-conductive layer. The skilled person would acknowledge that different sets of challenges apply in cable design for different voltage ranges.

The term color (of a material), as in the first, second, and third colors, shall be understood herein as a material property describing how light incident on a material's surface is reflected back from that surface as caused by reflections on and inside the material itself, but not from any background on which the material may be placed. A perceived shade of a color of a material, on the other hand, will additionally include any effect by a background on which the material may be placed. The color of the material is essentially caused by a composition (and, possibly, processing) of the material including any color pigment or agent therein. A color may be black, white, or grey, as well as a limited wavelength range or ranges of visible light, and a combination thereof.

The term optical depth as used herein is explained and defined as follows. Light rays that enter a translucent material through an entry surface thereof can scatter inside the material (typically on individual pigment particles and/or other crystalline regions in the material) such that the rays can change direction and scatter several times. The final outcome of each light ray is typically that it either exits the material through the entry surface but (generally) in a different direction, called diffuse reflection, or exits the material through a bottom or otherwise different surface (non-entry surface), or it is absorbed inside the material. The number of scatterings, the distance between scatterings depends on, but not limited to, distance, color and size of e.g. pigment particles and/or the base material which contain the pigment particles.

Color pigment and color agent (color additives) can mean added foreign coloring material or particles, including those resulting from local crystallization of a base material, and/or mixing of several base insulation materials to get a desired perceived color and, where applicable, translucency effects. These effects could even be attained by an addition of the same material as the base insulation material, but where the additive is in a different physical shape or form, for example as crystalline regions in 30 otherwise amorphous material, and/or a combination of several insulation materials that together achieve desired effects.

The average distance between each scattering is defined as the mean free path. The optical depth of the insulation layer of the inventive electrical cable is defined as the ratio of physical thickness and the mean free path. A material with an optical depth much less than 1 is therefore transparent to the majority of light rays, while a material with optical depth much larger than 1 is perceived as opaque. An object with an optical depth closer to 1 (0.5 through 10) is translucent, with an appearance that changes, if the color/lightness on the back-side object changes, and/or if the thickness of the object changes. By the definition used herein, the optical depth equals h/l, wherein h is the physical thickness of insulation layer and l is the mean free path between scatterings in the insulating layer.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1a shows a cross-sectional view of an inventive electrical cable having metallic wires surrounded by an inner semi-conductive layer, an insulating layer, and an outer semi-conductive layer. This cross-section is perpendicular to a central longitudinal axis of the electrical cable and it does not show any stripping of particular layers.

FIG. 1b shows the inventive electrical cable in a cross-section through the central longitudinal axis of the electrical cable. This view shows to the left a straight-cut left end and to the right a right end, in which the metallic wires extend further than the surrounding layers to facilitate termination or joining to another electric cable and the outer semi-conductive layer is stripped away (by cutting or similar) together with a radially outermost portion of the insulating layer. In a so prepared cable end, the distance though air between the inner and outer semi-conductive layers is larger than the radial thickness of the insulating layer (in the depicted case, more than five times the thickness).

FIG. 1c shows in a partial enlargement of FIG. 1b a radial distance D, which indicates a thickness of the radially outermost portion of the insulating layer that will typically also need to be removed in the process of completely stripping away the outer semi-conductive layer. A corner in the insulating layer created by the stripping is shown in FIG. 1c as a right-angle corner, although it should be understood that in practice the corner could be shaped rather as a taper or have a curved shape, which would generally make it more difficult to determine D, that is, how much of the insulating layer's thickness has been cut away in the stripping process.

FIG. 2 shows a diagram having a generally S-shaped curve of normalized reflected intensity of incident light (Normalized Color Intensity) as a function of optical depth of a translucent material (Optical Depth of the Insulation). The curve has a middle portion A that is approximately linear. The diagram aims to facilitate explanation about the intended light reflection properties of the insulating material after stripping away the outer semi-conductive layer (and a very small portion of the insulating layer). It enables estimation of the optical depth from a measurement of a color intensity of a physical cable's insulation layer.

FIGS. 3a-3c show an end portion of the inventive electrical cable. On the left side of the end portion, there is a section still having intact all three layers still surrounding the metallic wires. On the right side there is a section, in which the metallic wires have been freed from all three surrounding layers. Between these sections, there is an intermediate section, in which the outer semi-conductive layer has been stripped away. FIG. 3a shows the intermediate section with remaining patches of the outer semi-conductive layer (not a correct stripping). FIG. 3b shows the intermediate section with nothing left of the outer semi-conductive layer and a light appearance of the remaining insulating layer (a correct stripping). FIG. 3c shows the intermediate section with nothing left of the outer semi-conductive layer but with a darker appearance of the remaining (translucent) insulating layer indicating too much of it was removed (not a correct stripping).

FIG. 4 shows a light reflection value scale having a series of five different light reflectance surfaces (darker to lighter) for comparing to the remaining insulating layer after stripping. A check mark indicates two surfaces to be matched against the insulating layer to indicate correct stripping. At least one matching surface (having a certain light reflection value) and an inventive electrical cable may form an inventive kit.

FIG. 5 shows a flow chart of a method for stripping an inventive electrical cable.

### DETAILED DESCRIPTION

The present description provides an improved multi-layered lightweight high-voltage electrical cable, a method of stripping the inventive electrical cable and a kit. Corresponding items in different figures have the same reference numerals.

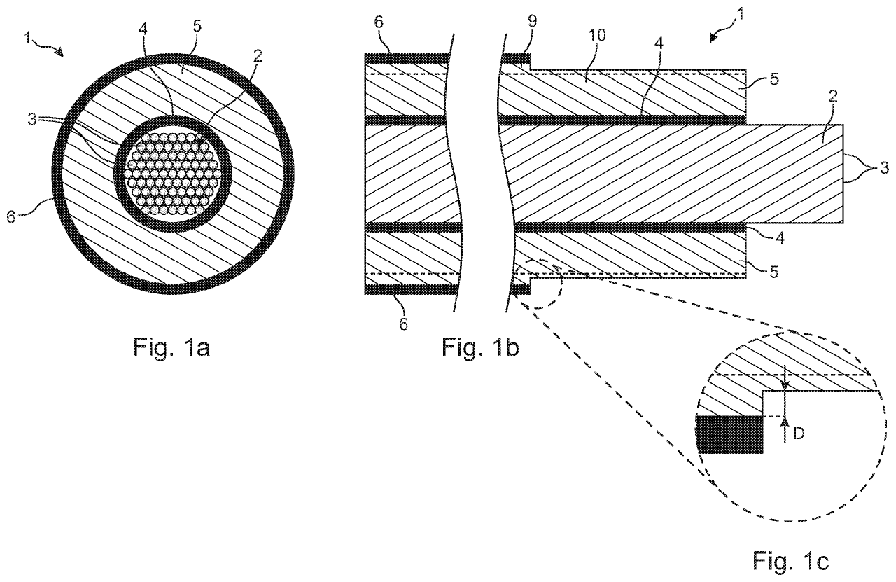

FIG. 1a shows a cross-sectional view of an inventive multi-layered lightweight high-voltage electrical cable 1 (MLLWHV electrical cable) having a bundle 2 of metallic wires 3, an inner semi-conductive layer 4, made of FEP, PFA, or ETFE material mixed with carbon particles to render it semi-conductive and thus black in color (the carbon particles work as black pigment), surrounding the bundle 2 of metallic wires 3, an insulating layer 5, made of FEP, PFA, or ETFE material mixed with TiO2 or ZnO pigment particles to render it essentially white and translucent to a degree, surrounding and having a void-free and delamination-resistant bond (VFDR bond) to the inner semi-conductive layer 4, and an outer semi-conductive layer 6, made of FEP, PFA, or ETFE material mixed with carbon particles to render it black in color and semi-conductive, surrounding and having a VFDR bond to the insulating layer 5. Thus, the color of the inner semi-conductive layer 4 contrasts to the color of the insulating layer 5, which in turn also contrasts to the color of the outer semi-conductive layer 6. To counteract the phenomenon of partial discharge in the insulating layer 5 when the electrical cable 1 is in high voltage operation, the void-freeness ensured in the VFDR bonds between the layers 4, 5, 6 is important. Arranging at least one of the metallic wires 3 in electric contact with the inner semi-conductive layer 4 also counteracts partial discharge.

Preferably, the materials of the inner semi-conductive layer 4, the insulating layer 5 and the outer semi-conductive layer 6 should be selected as one and the same from a group consisting of: FEP, PFA, ETFE, MFA, PEEK, a PAEK family material, silicones, fluoroelastomers, and the layers 4, 5, 6 should be co-extruded. Where materials with large similarity, e.g. FEP, PFA, and/or ETFE, can preferably be used together in the different layers. There is typically an additive in each layer that is or works like a pigment, most commonly carbon particles for the semi-conductive layers 4, 6 and TiO2, ZnO or PTFE for the insulating layer 5. To attain an appropriate translucency, it has been found that the second color additive should be mixed at less than 1 percent by weight in the insulating layer 5. For electrical and translucency properties, the particles of the color additive in the insulating layer 5 should be evenly distributed and/or have a particle size less than 10 micrometers.

The inventive electrical cable 1 may include such further layers, outside the outer semi-conductive layer 6, which are motivated by electrical, mechanical or other requirements.

FIG. 1b shows the electrical cable 1 in a cross-section through its central longitudinal axis. In the right end, the electrical cable 1 is prepared for a connection to a terminal or for a joint to another cable. Thus, the metallic wires extend further than the surrounding layers 4, 5, 6 and the outer semi-conductive layer 6 is stripped away together with a radially outermost portion of the insulating layer. In FIG. 1c, the partial removal of the insulating layer 5 is indicated by the thickness D. It is not an advantage, per se, to remove part of the insulating layer 5, it is instead a consequence of the need to ensure that nothing remains of the outer semi-conductive layer 5 after stripping. The thickness D should be small relative to the initial thickness of the insulating layer 5. From weight and resource preservation perspectives, the radial thickness of the insulating layer should not be greater than necessary in view of cable specifications. A distance through air between the inner semi-conductive layer 5 and outer semi-conductive layer 6 is more than about five times the (initial) thickness of the insulating layer. The exact shaping of the cable end through the stripping process will depend on which termination or joint is intended in a particular case.

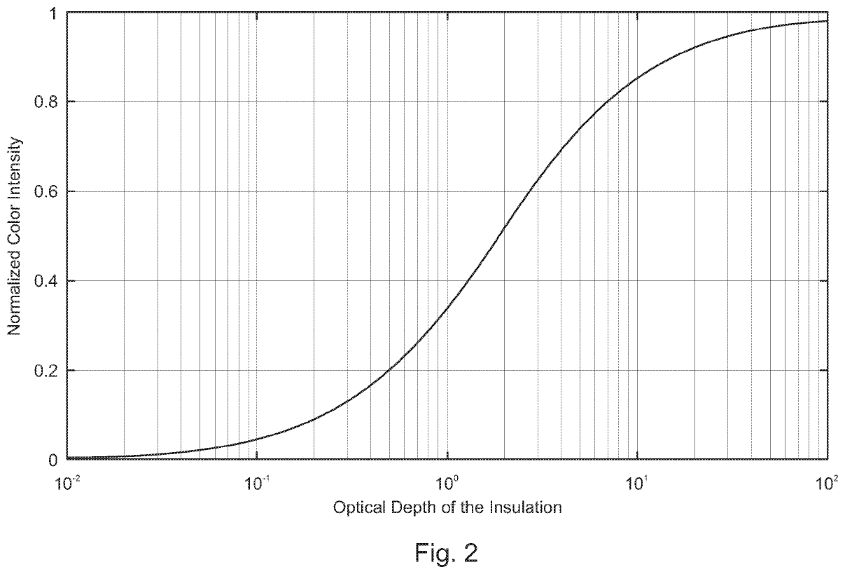

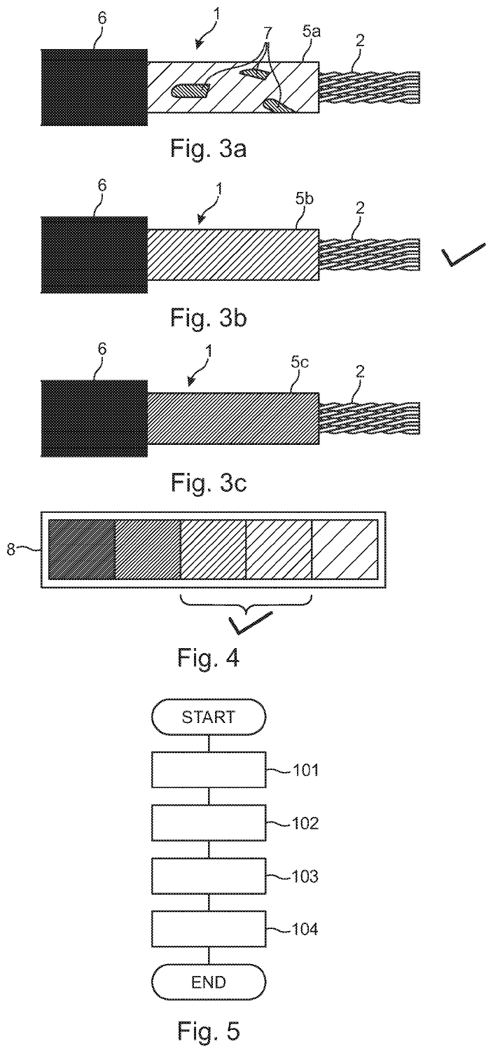

FIG. 2 shows normalized reflected intensity of incident light (linear scale) as a function of optical depth (logarithmic scale) of the insulating layer 5. An essentially opaque white insulating layer will have a great optical depth in the order of 100 and give a normalized reflected intensity rather close to 1. This will facilitate the identification by inspection of any black patches 7 of outer semi-conductive layer 5, as could be the case in FIG. 3a. Making the insulating layer 5 somewhat translucent, with an optical depth value such as between 0.5 and 10 (possibly even including between 0.1 and 0.5), light reflected at an envelope surface of the insulating layer 5 after stripping, would still enable identification of residual black patches of the outer semi-conductive layer 6 on the insulating layer 5. It would also enable identification of a correctly performed stripping as in FIG. 3b and a faulty stripping as in FIG. 3c, in which too much of the insulating layer 5 has been removed and less light is reflected (thus a darker shade) at the envelope surface of the remaining insulating layer. Note that since the inner semi-conductive layer 4 is black, there will be no reflection from it. Since the curve of FIG. 2 has a middle portion A that is steep and approximately linear, any optical depth value corresponding to that portion A will give a relatively large change in shade of the second color per unit of thickness of the insulating layer 5. This means that a strongly thickness dependent color or shade change is attained for the insulating layer 5

A general way of expressing the translucency of the insulating layer 5, is that that the first color of the inner semi-conductive layer 4 affects in combination with the second color of the insulating layer 5 a perceived shade of second color when the insulating layer 5 is viewed at its outer perimeter at full radial thickness of the insulating layer 5.

For electrical cables 1 having a very thin insulating layer 5 in a range of 0.4through 1.6 millimeters (preferably 0.4 mm-1.0 mm), the requirement for precision in the stripping is very high and thus the advantage is greater for a translucent insulating layer 5, which enables a more precise stripping. This thickness range for the insulating layer 5 relates closely to preferred voltage ranges for the inventive electrical cable 1. It is foreseen that electrical cables 1 with an insulating layer 5 thinner than the lower limit above will be rather difficult to handle for mechanical/precision reasons. However, the upper limit above is more important as it defines an upper limit of a thickness range within which the problems of correctly stripping the inventive electrical cable 1 are expected to be most pronounced in terms of its performance as a lightweight cable in high-voltage operation.

FIG. 4 shows a light reflection value scale having a series of five different light reflectance surfaces (darker to lighter) for comparing to the remaining insulating layer after stripping. A check mark indicates two surfaces to be matched against the insulating layer to indicate correct stripping. The electrical cable 1, in accordance with the foregoing, and the light reflection value scale in combination form a practical kit for precise stripping of the cable with a stripping tool cutting away the outer semi-conductive layer at just the right depth.

FIG. 5 shows a flow chart of method steps for stripping an electrical cable 1 in accordance with the above. The sequential method steps are: at an end of the electrical cable, stripping 101 away a longitudinal segment of the outer semi-conductive layer 6 and corresponding radially outermost parts of the insulating layer 5; ensuring 102, by color inspection, a complete removal of the longitudinal segment of the outer semi-conductive layer 6 from the insulating layer 5; ensuring 103, by color or shade inspection, a sufficiently great thickness of remaining insulating layer 5; and, optionally, including comparing 104 diffuse reflectance of remaining insulating layer 5 to a reflectance reference, such as the light reflectance value scale of FIG. 4, to ensure sufficiently great thickness of remaining insulating layer 5.

A possible further improvement for determination of correct stripping of the inventive electrical cable 1 is attainable as follows: the insulating layer 5 being formed by at least first and second distinct insulating sub-layers 9, 10 made of the second broad range temperature rated polymeric material and having the second color and a fourth color, respectively. At least one of the following should apply: the second and fourth colors preferably being contrasting to each other; the first and second insulating sub-layers 9, 10 preferably having a first and second translucency, respectively, which are not equal. Further, the first insulating sub-layer 9 has a VFDR bond to the second insulating sub-layer 10. Dotted lines in FIG. 1b indicate a possible interface between first and second distinct sublayers 9, 10.

A particularly efficient way of forming VFDR bonds in the inventive electrical cable 1 is attainable as follows: the respective VFDR bonds of the inner semi-conductive layer 4, the insulating layer 5, and the outer semi-conductive layer 6 are formed in a process of co-extrusion in manufacturing of the electrical cable 1.

Reference is now made primarily to FIGS. 1a-1c. Although not currently claimed, it should be understood that the invention also includes an electrical cable 1, in accordance with claim 1 or any one of the claims dependent thereon, further having at least one cable end portion including a longitudinal section (preferably of a length L being much greater than a thickness of the insulating layer 6), along which the outer semi-conductive layer 6 and an outermost (only) layer (preferably of thickness D much less than its total thickness) of the insulating layer 5 are both removed. In case of L, to facilitate the creation of a cable joint or termination, “much greater than” preferably means “at least five times”. In case of D, to avoid undue reduction of the insulating capacity in the insulating layer 5, “much less than” preferably means “at the most one fifth of”.

The person skilled in the art realizes that the present invention is not limited to the preferred embodiments described above. The person skilled in the art further realizes that modifications and variations are possible within the scope of the appended claims. Additionally, variations to the disclosed embodiments can be understood and effected by the skilled person in practicing the claimed disclosure, from a study of the drawings, the disclosure, and the appended claims.

1. A multi-layered lightweight high-voltage electrical cable, comprising:
a bundle of metallic wires;
an inner semi-conductive layer, made of a first broad range temperature rated polymeric material of a first color, surrounding the bundle of metallic wires;
at least one of the metallic wires being in electric contact with the inner semi-conductive layer;
an insulating layer, made of a second broad range temperature rated polymeric material of a second color, surrounding the inner semi-conductive layer;
an outer semi-conductive layer, made of a third broad range temperature rated polymeric material of a third color, surrounding and having a void-free and delamination-resistant bond (VFDR bond) to the insulating layer;
the second color and the third color contrasting with each other.

2. The electrical cable of claim 1, further comprising:
the first color and the second color contrasting with each other;
the insulating layer being translucent, such that the first color of the inner semi-conductive layer affects in combination with the second color of the insulating layer a perceived shade of second color when the insulating layer is viewed at its outer perimeter at full radial thickness of the insulating layer.

3. The electrical cable of claim 2, further comprising:
a translucency of the insulating layer being defined as an optical depth of the insulating layer being greater than or equal to 0.5 and less than or equal to 10.

4. The electrical cable of claim 1, comprising:
the first, the second, and the third broad range temperature rated polymeric materials of the inner semi-conductive layer, the insulating layer, and/or the outer semi-conductive layer being selected from the group consisting of: FEP, PFA, ETFE, MFA, PEEK, a PAEK family material, silicones, and fluoroelastomers.

5. The electrical cable of claim 1, comprising:
the first color being rendered at least partly by a first carbon particle additive in the inner semi-conductive layer.

6. The electrical cable of claim 1, comprising:
the second color being rendered at least partly by a second color additive in the insulating layer.

7. The electrical cable of claim 6, comprising:
the second color additive being selected from the group of consisting of: TiO2, ZnO, other inorganic metal oxides, and PTFE.

8. The electrical cable of claim 6, comprising:
the second color additive being a pigment of less than 1 percent by weight in the insulating layer.

9. The electrical cable of claim 6, comprising:
the second color additive being evenly distributed in the insulating layer and having a particle size less than 10 micrometers.

10. The electrical cable of any-one-of-the-preceding claim 1, comprising:
the third color being rendered at least partly by a third carbon particle additive in the material of the outer semi-conductive layer.

11. The electrical cable of claim 1, comprising:
the insulating layer providing secure insulation for electric potential differences greater than or equal to 500 volts AC or DC and less than or equal to 5 kilovolts AC or 30 kilovolts DC between the inner semi-conductive layer and the outer semi-conductive layer.

12. The electrical cable of claim 1, comprising:
an outer diameter of the outer semi-conductive layer being in a range of 3 through 20 millimeters.

13. The electrical cable of claim 1, comprising:
a manufactured radial thickness of the insulating layer being in a range selected among 0.4 through 1.0 millimeters, 0.4 through 1.6 millimeters, and 0.4 through 2 millimeters.

14. The electrical cable of claim 1, comprising:
the inner semi-conductive layer having a VFDR bond to the insulating layer.

15. The electrical cable of claim 1, comprising:
the third color being black; and
the second color being a shade of grey, including white.

16. The electrical cable of claim 1, comprising:
the first, the second, and the third broad range temperature rated polymeric materials being composed by the same polymers.

17. A method of stripping an electrical cable of claim 1, the method comprising:
at an end of the electrical cable, stripping away a longitudinal segment of the outer semi-conductive layer and corresponding radially outermost parts of the insulating layer;
ensuring, by color inspection, a complete removal of the longitudinal segment of the outer semi-conductive layer from the insulating layer.

18. The method of claim 17, comprising:
ensuring, by color or shade inspection, a sufficiently great thickness of remaining insulating layer.

19. The method of claim 17, comprising:
comparing diffuse reflectance of remaining insulating layer to a reflectance reference to ensure sufficiently great thickness of remaining insulating layer.

20. A kit comprising:
the electrical cable of claim 1; and
a reflectance reference surface to be visually matched against diffuse reflectance of the outer perimeter of the insulating layer after stripping away a longitudinal segment of the outer semi-conductive layer and corresponding radially outermost parts of the insulating layer.

21. The electrical cable of claim 1, comprising:
the insulating layer being formed by at least first and second distinct insulating sub-layers made of the second broad range temperature rated polymeric material and having the second color and a fourth color, respectively;
the second and the fourth colors being contrasting to each other;
the first and the second insulating sub-layers having a first and a second translucency, respectively, which are not equal; and
the first insulating sub-layer having a VFDR bond to the second insulating sub-layer.

22. The electrical cable of claim 14, comprising:
the respective VFDR bonds of the inner semi-conductive layer, the insulating layer, and the outer semi-conductive layer are formed in a process of co-extrusion in manufacturing of the electrical cable.
